(19) United States
(12) Patent Application Publication
(10) Pub. No.: US 2017/0236150 A1
(43) Pub. Date: Aug. 17, 2017

(54) PREDICTIVE PROGRAMMATIC SYSTEM FOR AUDIENCE IDENTIFICATION AND ANALYSIS

(71) Applicant: INVIDI TECHNOLOGIES CORPORATION, Princeton, NJ (US)

(72) Inventors: Howard Fiderer, Princeton Junction, NJ (US); David Downey, Sherman, CT (US); Michael Kubin, Princeton, NJ (US); Daniel Wilson, Edmonton (CA)

(21) Appl. No.: 15/043,493

(22) Filed: Feb. 12, 2016

(51) Int. Cl. G06Q 30/02; H04L 29/08

(52) U.S. Cl. CPC G06Q 30/0251; H04L 67/22; G06Q 30/0201; H04N 21/44222

(57) ABSTRACT

A predictive programmatic system (100) uses an addressable asset delivery system to provide audience information for non-addressable asset delivery opportunities. The illustrated system (100) is implemented in connection with an addressable asset delivery system (102) deployed, for example, in a cable or satellite television network. The addressable asset delivery system (102) is used to address assets to user devices 104 of a communications network. An asset provider may request dissemination of an asset over the communications network via a contracting platform (106). A targeting module (108) is operative for accessing audience information (110) and providing targeting information to the contracting platform (106). The audience information (110) may be developed by obtaining information regarding the audiences for addressable asset delivery opportunities and associated level of interest and conversion information, and the targeting module (108) may use information to characterize overall audiences for non-addressable asset delivery opportunities. This information can be provided to the contracting platform (106) to assist asset providers in identifying non-addressable asset delivery opportunities for specific assets of the asset providers.

### FIELD OF THE INVENTION

The present invention relates generally to audience identification in a communications network having defined asset delivery opportunities associated with network programming and, in particular, to using information and functionality of addressable asset delivery systems to estimate, identify, define and/or target audiences for non-addressable environments and provide audience analytics.

### BACKGROUND OF THE INVENTION

Many communications networks generate revenues or meet other objectives of the network operator by delivering advertisements, public service announcements or other assets in defined asset delivery opportunities associated with network programming. Examples of such networks include television and radio networks, as well as data networks that transmit streaming programming. The programming and assets may be delivered in real-time or may be time-shifted. The asset delivery opportunities can be conventional advertising spots that are interspersed with programming segments or product placement or other in-program advertising opportunities among others.

The case of television advertising is illustrative. In cable, satellite, and over-the-air broadcast environments, programming networks, local affiliates and others have traditionally sold access to advertising spots to advertisers. For example, a television program may include a 90-second advertising break that may be divided into 3 thirty-second spots. Advertisers may bid to secure access to those spots.

Today, those spots may be filled with conventional, non-addressable ads or, in some cases, with multiple addressable ads. In non-addressable or programmatic environments, an ad is inserted into the programming stream on a network-wide basis or on a local basis. In either case (local or network-wide), the same ad is delivered to all viewers of the program, at least within a network subdivision.

In the case of addressable environments, different viewers of a given program, even within a particular network subdivision, may receive different ads. This allows ads to be targeted based on location parameters independent of network topology, demographics, psychographics, or other targeting parameters of interest to an advertiser. Households or an individual user or users may be targeted based on classification parameters inferred from interaction with a set-top-box (“box”) or network, an identity or characteristics determined by sensors, information from network or third-party databases and/or other information sources. In this regard, “addressable” does not necessarily connote addressing of assets to terminals in a point-to-point (unicast) transmission, but also encompasses techniques by which specific assets can be delivered to specific terminals using broadcast or multi-cast protocols.

It should be noted that even in networks that support addressable advertising, much advertising is still delivered in a non-addressable mode. This is due to a variety of limitations. First, some boxes may not support addressable functionality. For example, in the case of satellite networks, a storage device such as a digital video recorder (that not all network users have) may be necessary to store targeted ads for subsequent insertion at the box. Similarly, in cable networks, some boxes may not have the resources and logic required for executing addressable advertising. Over-the-air television generally does not support addressable advertising today and addressable advertisers has not reached all areas. Moreover, some users may opt not to receive addressable advertising where that option is provided by the network.

Even where the equipment and network allows for addressable advertising, much advertising inventory may be delivered in a non-addressable mode. For example, bandwidth limitations may impose a practical limit on the number of spots that can be populated with addressable ad options. In addition, an addressable advertising system may only be implemented for either network-wide (e.g., national) or local spots. Typically, today, in the United States, perhaps about 16 minutes per hour is composed of advertising, of which about 14 minutes may be network-wide spots and two minutes are available for local ads. Also, network operators may choose to sell full spots rather than audience segments for business or other reasons.

Whether in addressable or non-addressable environments, advertisers generally desire to target advertisements to defined audiences within the limitations of the advertising environment. In conventional, non-addressable environments, this can be accomplished by using ratings information. Such ratings are generally obtained by monitoring the viewing behavior of viewers who have agreed to participate and have specialized equipment. By monitoring the programs watched by those viewers, and correlating those programs to known demographic information for those viewers, ratings can be developed that characterize the audience composition for certain programs in terms of various demographics, e.g., age, gender, and income. Because the monitored viewers comprise a relatively small portion of all viewing households, reliable and complete ratings information may be limited to programs having large viewing audiences that yield a statistically significant sampling for at least some demographics.

Armed with this ratings information, advertisers can bid on spots in programs with an audience that is attractive to the advertiser. Generally, this involves identifying a program that “indexes higher” than average for the target viewing audience of the advertiser and bidding on a spot within or adjacent to that programming. In this regard, if the target audience for a given advertiser is women aged 35-49, and if, on average, women aged 35-49 make up 10% of the viewing audiences in the network for the time-slot under consideration, then a program that has an audience of more than 10% women aged 35-49 as indicated by ratings is said to index higher for that demographic. In many cases, the winning bidder for a spot may have a targeted audience that makes up only a small minority of the overall audience for that program (notwithstanding that the program indexes higher for that demographic) and, indeed, may have a targeted audience smaller than that of other bidders. Moreover, advertisers with a target audience that does not match any set of attributes for which ratings are available (e.g., current Ford owners or undecided voters in the Fifth Congressional District) are forced to identify sets of rated attributes that can serve as proxies for the attributes of the targeted audience or otherwise identify targeted spots (e.g., via independent research).

Addressable advertising systems have only recently been deployed on a widespread basis. In particular, the Advatar® system of Invidi Technologies Corporation has gained widespread deployment, especially in North America, and currently delivers more than 9 billion targeted impressions per month. The Advatar system allows advertisers to target viewers who match the advertising parameters specified by the advertisers, even when those parameters do not align with ratings attributes or where ratings may otherwise be unavailable. In this manner, viewers receive more accurately targeted ads and advertising resources are deployed more effectively.

Though the specific features vary for particular deployments, the Advatar system has a number of useful capabilities. Three of particular interest for present purposes are audience classification, voting, and reporting. Third-party databases are of particular interest for present purposes may be such items as audience classification, voting, and reporting, but are limited to this scope and aspect. As noted above, audience classification relates to determining attributes of a household or individual that may be of interest to an advertiser in targeting ads. The Advatar system can obtain information on an individual basis in substantially real-time so that classification parameters pertain to who's watching now. Moreover, in certain implementations, very rich classifications can be derived that are not limited to the attribute sets of conventional ratings systems. This information may be based on accessing a third-party database of demographic, psychographic, financial, and purchasing information and/or based on estimates of a classifier that monitors a click-stream of inputs entered by the viewer(s) via a remote control.

Voting can be implemented in deployments where limited bandwidth is available for transmission of addressable ad options. In such cases, it is desirable to optimize usage of that bandwidth. This can be accomplished by a voting process whereby a list of ad options, targeting parameters, and associated program/channel associations is sent to at least some boxes shortly before a spot for which addressable ads will be available. Boxes tuned to a relevant channel can vote for one or more ads where the targeting parameters match the classification parameters of the current viewer or viewers. In this manner, an optimal set of ad options can be made available based on feedback concerning current network conditions, e.g., what kind of people are tuned to which programming networks now. It should be noted that a residence of the overall audience (e.g., composed of a non-addressable segment of the audience together with a targeted segment and addressable boxes that did not match any available ad option), may receive a default ad inserted into the programming stream.

Reporting may be utilized regardless of whether voting is employed. Reporting is the process by which at least some individual boxes report to the communications network after an addressable ad has been delivered. For example, the report may indicate what ad was delivered, in connection with which spot or programming network/program, and various other information as will be described in more detail below. It will be appreciated that, where ad delivery decisions are made at the box, reporting is useful to allow for determination of delivery data for billing and provide for guaranteed delivery of targeted impressions. Even where decisions are centrally directed, e.g., based on instructions from the headend or another network platform, a broadcast network typically does not know which boxes are on, what channel the boxes are turned to and cannot provide accurate delivery data in the addressable advertising context absent reporting.

The reports can also be used to generate further analytics of interest of advertisers, network administrators, and others. Such analysis can involve developing information concerning levels of interest (“LOI”) and conversions by audience members. In this regard, the reports may provide information regarding a level of interest or lack thereof by the audience receiving the ad. For example, the report may indicate that some viewers tuned-away during the ad or muted the ad. In addition, the report may indicate a confidence level that the viewer was present and engaged (e.g., based on how long it has been since the viewer last interacted with the box) and may provide information regarding attributes of the current audience (e.g., how many viewers, how well they match the targeting parameters for the ad, current estimates of classification parameters, or a putative identification of a current viewer). Such interest information may be analyzed today, for example, to gather information concerning ad effectiveness.

Conversions refer to events where a viewer takes some action desired by the advertiser after viewing the ad. Examples include visiting a website of the advertiser or otherwise requesting additional information taking some specific action such as a test drive or ordering a free sample, and, of course, purchasing the product or service advertised. The last of these is perhaps the ultimate measure of ad effectiveness. Information concerning conversions may be obtained from internal or external sources. With regard to internal sources, an example is inputs to a Request for Information (RFI) program. In some cases, in connection with addressable advertising systems, it is possible for a viewer to request more information in relation to an ad or other content. For example, the user may provide a designated remote control input during an ad or submit an alphanumeric code or other identifying information to a website or RFI platform. In response, the user can obtain further product information, promotional information, offers or the like.

External sources of information can be used, for example, to monitor subsequent purchasing decision of an audience member. Potential sources of such information include credit card records, store loyalty program records, new vehicle registrations, and surveys among others. Still further potential sources of direct responses purchases may include a 1-800 number, online ordering or help desk or the like. Report information can be correlated to such purchasing decision information to determine whether audience members have purchased a product (or a competitive product or a related product) after viewing an ad or set of ads. Considered collectively, classification information, voting, reports, and information concerning interest and concerning conversions provide a tremendous amount of audience information related to addressable advertising systems, particularly, in view of the volume of targeted impressions now being delivered by systems like the Advatar system.

### SUMMARY OF THE PRESENT INVENTION

It has been recognized that certain information and functionality of addressable asset delivery systems (e.g., addressable advertising systems of broadcast networks) can be used in contexts not limited to addressable asset delivery. In particular, information concerning audiences for addressable assets can be used to identify and characterize asset delivery opportunities in non-addressable (programmatic) contexts. In addition, information regarding interest levels and conversions, e.g., related to addressable assets, can be used to improve identification of targeted audiences and selection of asset delivery opportunities for addressable and non-addressable assets. Certain resources of an addressable asset delivery system, such as audience classification and measurement systems, can be used in predictive analyses to define audiences and asset delivery opportunities or to develop information concerning how assets effect behavior. Such resources can be deployed in relation to actual or hypothetical assets, experimental asset delivery campaigns, or to capture audience information independent of assets. Moreover, network usage by targeted audience members can be tracked to identify additional asset delivery opportunities. In this manner, information and resources associated with an addressable advertising system can be used to improve targeting in non-addressable contexts and improve asset targeting analytics.

In accordance with one aspect of the present invention, a utility is provided for using an addressable asset delivery system to provide audience information for non-addressable asset delivery opportunities. The addressable asset delivery system is operative for addressing assets to audience members in connection addressable asset delivery opportunities and includes a communications module for processing audience information related to communications between a platform of the addressable asset delivery system and user equipment devices. For example, the addressable asset delivery system may obtain information regarding the size and composition of an overall audience or audience segment for an upcoming or recent asset delivery opportunity based on the communications. Based on this audience information, the addressable asset processing module can provide targeting information for use in a non-addressable context associated with the same or a different asset delivery opportunity. It will be appreciated that a single asset delivery opportunity may have both an addressable audience and a non-addressable audience (e.g., the residue of the overall audience that receives the default asset in an addressable asset delivery opportunity). The invention thus enables the use of fine and highly relevant audience classification information, obtained in relation to targeting parameters of an addressable asset, to optimize targeting in a non-addressable context.

The audience information can be used to select a non-addressable asset delivery opportunity for a given asset or targeted parameters. In this regard, the invention can include a non-addressable module for matching asset delivery requests to non-addressable asset delivery opportunities. The module can receive non-addressable targeting information concerning a non-addressable asset delivery opportunity and receive an asset delivery request specifying targeting parameters for an asset. The targeting parameters for the asset can then be compared to the audience information concerning the non-addressable asset delivery opportunities to select one or more of the non-addressable asset delivery opportunities responsive to the first asset delivery request. Thus, for example, an asset provider may select a non-addressable asset delivery opportunity deemed to index higher than average with respect to the targeted audience for an asset. The asset delivery opportunity may be defined in relation to one or more programming networks, one or more communications networks, one or more local affiliate areas, and/or one or more network subdivisions of other geographies.

A variety of types of audience information obtained from a variety of sources may be used in this regard. For example, the audience information may be based on communications between the platform of the addressable asset delivery system and the user equipment devices, where each communication relates to characterizing a current audience of a given user equipment device. For example, the audience information may reflect one or more classification parameters for the given user equipment device or current audience. Additionally or alternatively, the audience information may identify a bandwidth segment delivered to the current audience. Such information may be provided in relation to an actual asset delivered or proposed to be delivered (e.g., voting or report information) in connection with an asset delivery opportunity. Alternatively, communications may be transmitted between the platform and user equipment devices independent of any particular asset, e.g., in connection with a polling process or a hypothetical asset used to gather audience information. The audience information may further include level of interest information for audiences of addressable assets or conversion information for such audiences. In this manner, decisions can be informed not only by audience composition but also based on asset effectiveness.

In accordance with another aspect of the present invention, information concerning asset effectiveness is used to identify asset delivery opportunities including non-addressable asset delivery opportunities. An associated utility involves operating a targeting module to receive asset delivery information for multiple delivered assets. One or more of the assets may be delivered as part of an experimental campaign designed to generate desired audience information. The experimental campaign may have a reach, duration and other parameters selected to measure potential audience and campaign characteristics. For each delivered asset, the asset delivery information includes audience information concerning audience members that receive the asset, classification parameters of an audience that received the delivered asset and audience engagement information concerning one or both of level of interest information and conversion information. The targeting module further receives an asset delivery request for prospective delivery of a subject asset. The delivery request includes one or more targeting parameters for the subject asset. The targeting module is then operative to identify one or more asset delivery opportunities for the subject asset based the asset delivery information and the targeting parameters.

For example, a first asset may have targeting parameters defining a targeted audience for delivery for the first asset. Alternatively, the targeting parameters may relate to a subject matter of the associated programming or other program-related characteristics. The targeting module may then determine engagement parameters for the first asset based on the engagement information where the engagement parameters define an engaged audience for the first asset different than the targeted audience. The targeting module can then identify one or more asset delivery opportunities based the engagement parameters In accordance with an still further aspect of the present invention, information harvested from an addressable asset delivery system may be used to identify or further define the target audience for an asset, e.g., in connection with identifying an appropriate asset delivery opportunity or otherwise. The harvested information may include delivery statistics, level of interest information, and/or conversion information. The harvested information may be obtained in relation to addressable or non-addressable asset delivery opportunities. For example, an asset provider may elect to place an asset in a non-addressable spot. The addressable asset delivery system may obtain information regarding the size or composition of the audience for the asset and this information may be used by the asset provider or others in developing asset delivery analytics. Alternatively, an asset provider may elect to deliver an asset to a selected audience segment of an addressable asset delivery opportunity. The addressable asset delivery system may then provide information regarding the size of the audience segment and other opportunities for reaching the audience members. As a still further alternative, level of interest information and/or conversion information may be utilized to provide analytics useful for asset placement and other purposes.

The analytics may allow an asset provider to identify a target audience that is different or more specific than previously understood. For example, an asset provider may identify its target audience as males over the age over 21. Based on level of interest data or conversion data, a targeting module may identify males aged 35-49 as having a high level of engagement with respect to the asset. For example, the engagement information may be based on previous placements of the same asset, other assets related to similar products or services, or asset placements otherwise deemed to be probative of the engagement parameters.

In accordance with a still further aspect of the present invention, certain functionality of an addressable asset delivery system can be used to generate audience analytics independent of delivery of addressable assets. For example, the addressable asset delivery system may include resources for enabling bi-directional communication between a platform of the addressable asset delivery system and user equipment devices, e.g., for purposes of voting, reporting, or the like. Such resources can be utilized to poll user equipment devices to obtain information concerning audience size and composition for a given time slot, bandwidth segment, asset delivery opportunity, or other audience of interest. Similarly, hypothetical asset delivery requests may be generated so as to induce user equipment devices to vote, report, or otherwise signal in relation to targeted parameters of hypothetical assets. For example, an asset provider may purchase the entirety of an asset delivery opportunity in connection with a prime time television program on a major programming network. The targeted advertising system may distribute a list of hypothetical assets with hypothetical targeting parameters in connection with the asset delivery opportunity. User equipment devices may then vote, report, or otherwise signal the targeted asset delivery system with regard to the hypothetical assets even though the hypothetical assets are not actually available for delivery. In this manner, highly specific and customized information can be obtained regarding the composition of the audience. Hypothetical asset delivery requests may also be utilized in connection with addressable asset delivery opportunities hypothetical asset delivery opportunities, or independent of any asset delivery opportunities. Moreover, experimental campaigns can be executed thereby providing the opportunity to obtain level of interest and conversion data in relation to specific assets, targeted audiences, particular delivery times or programming associations, etc. In this regard, different assets, different asset delivery opportunities, control groups and the like may be employed to enhance definition of the analytics at issue. This information may be used for a variety of purposes including characterizing future asset delivery opportunities and demonstrating the value of addressable asset delivery.

In accordance with a still further aspect of the invention, audience information is used together with network usage information to identify asset delivery opportunities. This may be implemented using resources of an addressable asset delivery system. As noted above, addressable asset delivery systems may include information identifying a user or user equipment device that received a particular asset. Network usage by the user or user device may then be tracked to identify other asset delivery opportunities where the user or device can be reached. Thus, for example, new asset delivery opportunities may be identified that index higher than average for a targeted audience segment or otherwise include a notable aggregation of targeted users. A significant targeting advantage can therefore be realized even with respect to non-addressable asset delivery opportunities.

### BRIEF DESCRIPTION OF THE DRAWINGS

For a more complete understanding of the present invention and further advantages thereof, reference is now made to the following detailed description taken in conjunction with the drawings, in which:

FIG. 1 is a schematic diagram of a predictive programmatic system in accordance with the present invention; and

FIGS. 2-6 are flow charts illustrating various use cases of the predictive programmatic system of FIG. 1.

### DETAILED DESCRIPTION

The present invention is directed to a system and associated functionality that uses information and resources of an addressable asset delivery system to improve audience analytics and targeting in a communications network. In particular, information and resources from an addressable asset delivery system can be used to enhance targeting for spot buys or programmatic buying where whole asset delivery opportunities are purchased for non-addressable asset delivery. In addition, information and resources of an addressable asset delivery system can used to provide a variety of predictive analytics for use in programmatic buying and other purposes.

In much of the following discussion, the invention is set in forth in the context of using information and resources of a targeted advertising system deployed in a broadcast television environment for targeting non-addressable television advertising spots. While this represents a high value implementation of the present invention that leverages the attributes and volume of data available in currently deployed targeted advertising systems, the invention is not limited to this context or network environment. The following description should therefore be understood as illustrating the various aspects of the present invention and not by way of limitation.

The following description begins with a high level description the functional components of the present invention. Thereafter, various aspects of the invention are illustrated in relation to a number of use cases. While these use cases illustrate various possibilities for implementing the present invention, they are not intended to be exhaustive. Additional uses of the invention will be readily apparent to those skilled in the art.

### The Predictive Programming System

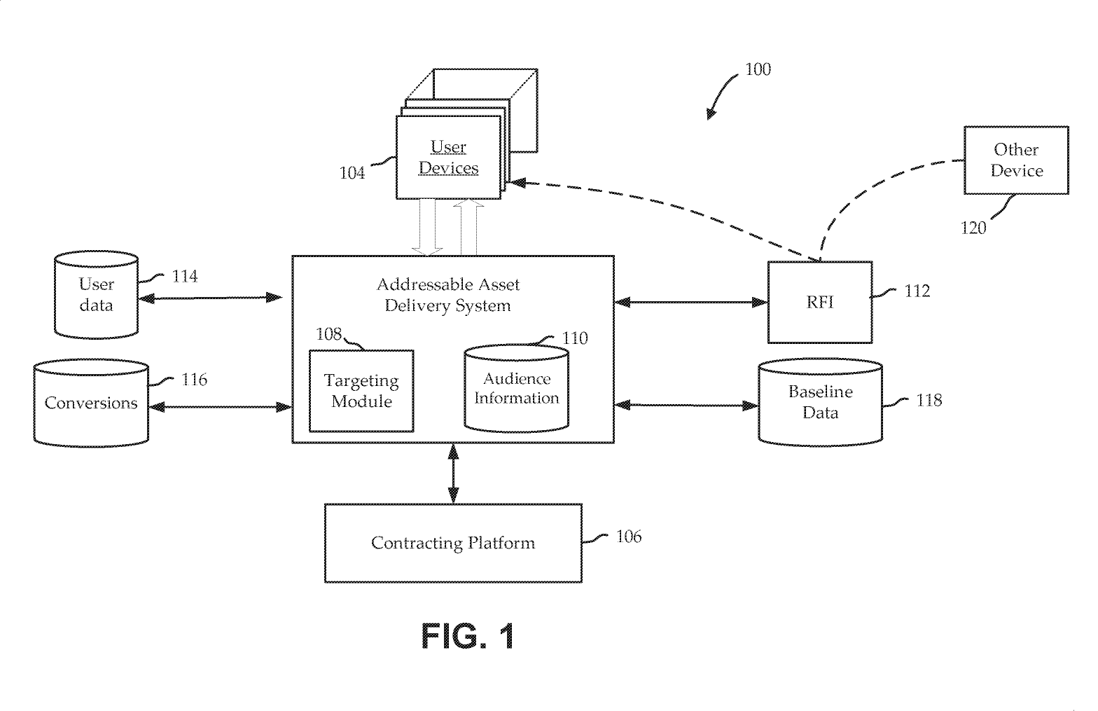

Referring to FIG. 1, a predictive programmatic system 100 in accordance with the present invention is illustrated. The illustrated system 100 is implemented in connection with an addressable asset delivery system 102 deployed, for example, in a cable or satellite television network. The addressable asset delivery system 102 is used to address assets to user devices 104 of a communications network. In particular, the assets are addressed to the user devices 104 such that different user devices 104 can receive different assets. The particular asset delivered to a given user device may be selected based on one or more classification parameters of the user device or current audience, i.e., user or users, of the user device. Such classification parameters may relate to a location of the user device, demographics or psychographics of the current audience, or any other information of interest to an asset provider. The assets may be delivered in connection with network programming. For example, asset delivery opportunities may be provided in connection with an advertising break in or adjacent to identified programming or may be provided as product placement or other advertising opportunities within programming.

The classification parameters of the user can be determined or estimated in various ways. For example, a classifier resident on the box or an upstream platform may monitor a clickstream of remote control inputs to identify programs selections, volume settings, surfing behavior, viewing time patterns, and the like so as to progressively estimate characteristics of the current viewing audience. It is also possible to use a customer list of the network provider together with detailed financial and purchasing behavior records of a third-party database to obtain detailed information for a household or individual network user. Both of these systems (a classifier and a third-party database) can be used to combine the benefits of such third-party database information with the specificity of who's watching now as indicated by a classifier.

Assets may be addressed to individual users or groups of users based targeting parameters that are generally specified by asset providers but may alternatively or additionally be based on preferences of users, network providers, or others. For example, an asset provider may request dissemination of an asset over the communications network via a contracting platform 106. In this regard, the asset provider may use one or more user interfaces of the contracting platform 106 to enter information identifying a targeted audience and other campaign information. The targeted audience may be identified based on location, demographic characteristics of the targeted audience, included or excluded programming networks, relevant programming subject matter or textual constraints related to programming, time of day or day of the week preferred for asset delivery, or other parameters. The additional campaign information may relate to a total number of desired impressions, pacing or frequency constraints for delivery of an asset, a desired sequencing of asset delivery, and the like.

In the illustrated embodiment, the addressable asset delivery system 102 further includes a targeting module 108 and audience information database 110. Though these elements 108 and 110 are conceptually illustrated as being part of the addressable asset delivery system 102. It will be appreciated that elements 108 and 110 may be disposed at different locations from other elements of the addressable asset delivery system 102 and each other, may be provided and/or operated by different parties, and may be distributed across multiple machines disposed in multiple locations and operated by multiple parties.

The targeting module 108 is operative for accessing audience information 110, as will be developed as discussed in more detail below, and providing targeting information to the contracting platform 106. For example, the audience information 110 may be developed by obtaining information regarding the audiences for addressable asset delivery opportunities and associated level of interest and conversion information, and the targeting module 108 may use information to characterize overall audiences for non-addressable asset delivery opportunities. This information can be provided to the contracting platform 106 to assist asset providers in identifying non-addressable asset delivery opportunities for specific assets of the asset providers.

In this regard, the audience information 110 may be based in part on messages exchanged between the addressable asset delivery system 102 and the user devices 104. The nature of those messages can vary depending on the network environment. For example, in some network environments, click-stream or other status information is directly available at network platforms upstream from the user devices. For example, in unicast or switched digital network environments, click-stream information or user inputs may be directly transmitted to a network platform. The network may therefore be able to determine whether the user device is on, what programming or content is being delivered and other information. In other network environments, such as broadcast environments, the messaging may relate to implementation of addressable assets delivery. For example, an addressable asset delivery system may include voting and/or reporting functionality. In this regard, the addressable system may transmit to the user devices 104 an asset list, targeting parameters, and prompts relating to voting and reporting and may receive from the user device 104 votes, reports, and other information concerning assets and classification information. The user device 104 may also provide information concerning levels of interest and requests for information associated with assets. This information can be used in compiling the audience information 110.

In the illustrated embodiment, the addressable asset delivery system 102 is also associated with a Request for Information (RFI) system 112, a user data system 114, and a conversions data system 116. Although these elements 112, 114, and 116 are shown as being separate from the addressable asset delivery system 102, these elements 112, 114, and 116 could alternatively be conceptualized as being a part of the addressable asset delivery system 102. Moreover, although these elements 112, 114, and 116 are shown as being separate elements, it will be appreciated that these 112, 114, and 116 could be implemented as part of a single system executed by the same machine or machines. Similarly, each of the elements 112, 114, and 116 can be implemented on a single machine or could be distributed over multiple machines at different locations and can be operated by a single or multiple parties.

The RFI system 112 is operative to collect and process requests for information associated with particular assets. Such requests may be communicated to the RFI system 112 from the addressable asset delivery system 102, directly from the user devices 104 or from other devices 120. For example, in a cable television environment, an addressable asset may be delivered to a user device 104. The asset may include an alphanumeric code or other prompt notifying the user that additional information is available. In response to the prompt, the user may enter an input via the user device 104 which is then communicated via the cable television network to the addressable asset delivery system 102 and in turn to the RFI system 112. In response to the request for information, the RFI system 112 may make additional information available to the user, for example, via email or a portal of the RFI system 112. In this manner, a television viewer that is interested in a television commercial can subsequently access a website of the advertiser to get additional information or promotions, or to purchase products or services of the advertiser.

Alternatively, a request for information can be transmitted directly from the user device 104 to the RFI system 112. For example, a user may transmit identifying information associated with an asset directly to RFI platform 112 via a data network such as the internet. The identifying information may include a code, a screen shot of the asset captured by the user, an audio recording of a portion of the asset, or any other information that can identify the asset of interest. The information may be transmitted using the user device 104 or another device such as a cell phone, tablet, or other data terminal.

As a still further alternative, a user may enter information to the RFI system 112 via another device 120. This information may pertain to an asset of interest, a related asset, related subject matter, or other information. For example, a user may see a product of interest or advertisement of interest independent of network programming. In this regard, the user may capture a photograph or bar code of a product of interest, a billboard or advertisement in print or other media, or the like. The user can upload this information to the RFI system 112 and the information may subsequently be used by the addressable asset delivery system 102 and the predictive programmatic system 100 more generally as will be described in more detail below. The addressable asset delivery system 102 may use such information to provide targeting information to the contracting platform 106 and to address assets to the user devices 104.

The addressable asset delivery system 102 may exchange information with the user data system 114 for a variety of purposes. For example, the user data system 114 may be a third-party database that has access to financial information and transaction information. For example, the user data system 114 may be associated with a global information services company that collects financial information from financial institutions, credit card purchase information from credit card transactions, and other information. The addressable asset delivery system 102 can provide a list of network users or associated information to the user data system 114 and receive back detailed information for use in addressing assets to the user devices 104. Similarly, the addressable asset delivery system 102 can provide a list of users who have received a particular asset and obtain information from the user data system 114 regarding subsequent activities of the user.

The addressable asset delivery system 102 can also exchange information with a conversions system 116. A variety of types of conversions may be of interest in this regard. Examples include the user accessing a website of the asset provider after receiving an asset, the user contacting the asset provider, a partner, or retail outlet after receiving an asset, or the user may purchase a product or service of the provider or a related product or service after receiving the asset. The source of the conversion information depends in part on the nature of the conversion activity. Thus, the conversion system 116 may collect information from asset providers, retail outlets, data networks, phone networks, and other sources. With respect to transaction information, the conversion information may be obtained from, among other sources, information obtained in connection with loyalty programs of retail outlets. For example, such information may indicate that a user purchased a product of an asset provider or a competitive product after receiving an asset.

The illustrated addressable asset delivery system 102 also receives baseline data 118 from one or more sources. It will be appreciated that certain analyses, such as identifying asset delivery opportunities that index higher than average for a defined demographic, require baseline data such as (in the case) average index values. Such information may be based on ratings information, phone surveys, other addressable asset delivery systems, census data, internet behavior or other sources.

From the foregoing, it will be appreciated that the user devices 104 may include a variety of different types of equipment depending on the network environment and other factors. For example, the user devices may include television sets, set-top boxes, digital video recorders, tablets, cell phones, or other data terminals, radios or other audio devices, or other equipment. In the specific context of television programming, the user devices 104 may include a cable set-top box, a satellite set-top box, a television set, or a streaming device.

While a general description of the predictive programmatic system 100 and its various components has thus been set forth to understand the operation of the predictive programmatic system 100, further details are set forth in the applications and patents listed below, all of which are hereby incorporated by reference. The addressable asset delivery system 102 and its functionality including developing audience classification parameters, voting, and reporting is set forth in U.S. Pat. No. 8,108,895, filed on Jan. 12, 2006, entitled, “CONTENT SELECTION BASED ON SIGNALING FROM CUSTOMER PREMISES EQUIPMENT IN A BROADCAST NETWORK,” U.S. Pat. No. 7,698,236, issued on Apr. 13, 2010, entitled, “FUZZY LOGIC BASED VIEWER IDENTIFICATION FOR TARGETED ASSET DELIVERY SYSTEM,” and U.S. application Ser. No. 13/663,780, filed on Oct. 30, 2012, entitled “METHOD AND APPARATUS TO PERFORM REAL-TIME AUDIENCE ESTIMATION AND COMMERCIAL SELECTION SUITABLE FOR TARGETED ADVERTISING.” Various functionality of the RFI system 112 and level of interest information is set forth in U.S. patent application Ser. No. 13/191,370, filed on Jul. 26, 2011, entitled, “UNIVERSALLY INTERACTIVE REQUEST FOR INFORMATION,” and U.S. Pat. No. 8,146,126, issued on Mar. 27, 2012, entitled, REQUEST FOR INFORMATION RELATED TO BROADCAST NETWORK CONTENT.” Information relative to the user data system 114 and conversion system 116 is also available in U.S. patent application Ser. No. 13/870,870, filed on Apr. 25, 2013, entitled, “THIRD PARTY DATA MATCHING FOR TARGETED ADVERTISING.” The operation of the predictive programmatic system 100 will now be further described in relation to a number of use cases.

### Use Case 1: Targeting Non-Addressable Assets

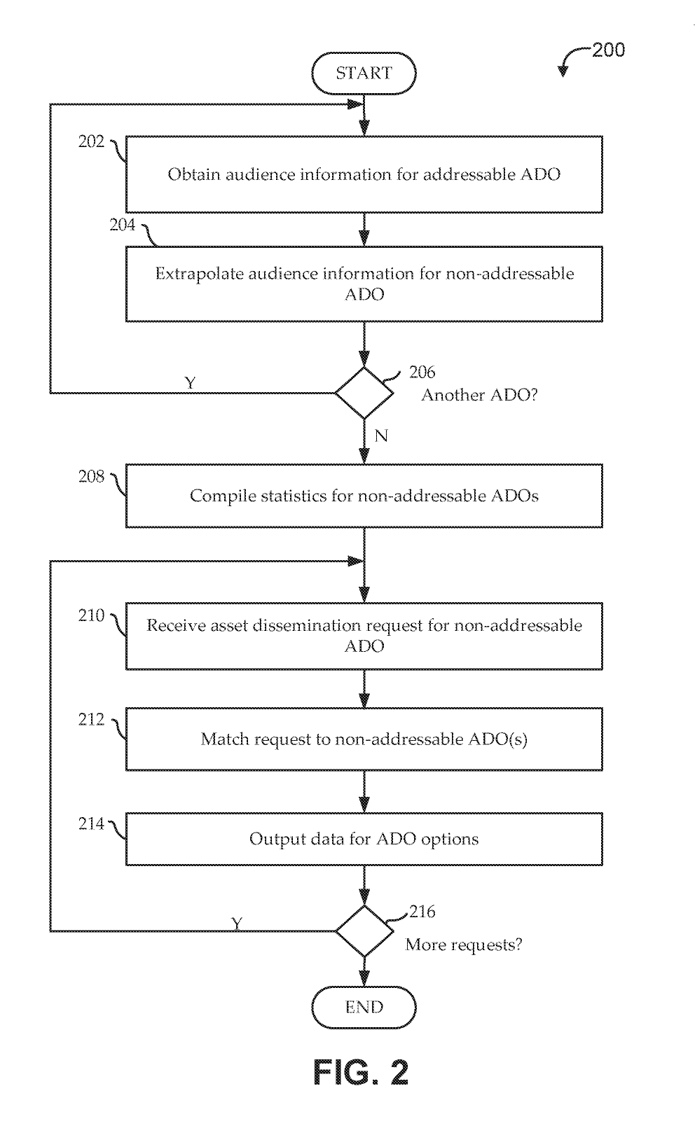

FIG. 2 illustrates a process 200 for targeting non-addressable assets using the predictive programmatic system of FIG. 1. The illustrated process is initiated by obtaining (202) audience information for one or more addressable asset delivery opportunities. For example, if the goal is to obtain targeting information for a non-addressable portion of an asset delivery opportunity, audience information may be obtained for the addressable portion of the same asset delivery opportunity or a similar asset delivery opportunity. Based on this information, the system can extrapolate (204) audience information for the non-addressable asset delivery opportunity or non-addressable audience portion of an asset delivery opportunity.

The audience information obtained for the addressable asset delivery opportunity may need to be adjusted for a number of reasons. First, if the overall audience for the addressable asset delivery opportunity is different in size from the non-addressable asset delivery opportunity to be targeted, the target audience size may need to be scaled or otherwise adjusted. In addition, it may be determined that the addressable asset delivery opportunity audience has a systematic bias in relation to the anticipated non-addressable asset delivery opportunity audience. For example, in systems where assets can only be addressed with respect to users who have digital video recorders, the addressable audience may be biased in relation to income in a manner that can be accounted for. In any event, once the audience information is obtained and information for the non-addressable asset delivery opportunity is extrapolated, the system has some evidence as to the likely audience size for the non-addressable asset delivery opportunity.

In many cases, it is possible to improve the estimate for the non-addressable asset delivery opportunity by acquiring additional information related to additional addressable asset delivery opportunities. For example, the uncertainty in estimating the size of an audience for a non-addressable asset delivery opportunity may be reduced by employing an iterative process for similar asset delivery opportunities so as to obtain further evidence for use in computing the estimate for the non-addressable opportunity. Thus, as shown in FIG. 2 the system may determine (206) whether sufficient evidence has been obtained. For example, the system may require that information be obtained for at least for a predetermined number of addressable asset delivery opportunities or a predetermined overall audience size before yielding an estimate of the audience for the non-addressable e asset delivery opportunity.

Once the system has obtained sufficient information to provide an estimate of the audience for the targeted non-addressable asset delivery opportunity, the system can compile (208) statistics for the non-addressable asset delivery opportunity. This process may be repeated for multiple non-addressable asset delivery opportunities so as to build a data base of audience information. In particular, audience estimate information may be indexed to particular targeting parameters or combinations of targeting parameters or the information may be intelligently processed to yield estimates for non-addressable asset delivery opportunities even where the exact combination of targeting parameters has not been previously estimated. In this regard, various audience modeling techniques and machine learning logic may be employed to mine the data from the database so as to yield meaningful estimates. For example, a predictive model may be developed using statistical tools such as a classification and regression tree (CART) and neural network analyses.

The illustrated process 200 further involves receiving (210) an asset dissemination request for a non-addressable asset delivery opportunity. For example, an asset provider may be interested in making a spot buy or programmatic buy for the entirety of an identified spot provided in connection with network programming. In order to submit an appropriate bid, the asset provider may enter targeting parameters for the asset and request an estimate of the size of the target audience. Alternatively, the asset provider may enter a request for dissemination by entering the targeting parameters and a desired number or rate of targeted impressions to be delivered. In response, the contracting platform may identify one or more assets delivery opportunities to satisfy the dissemination request.

In the later regard, the system may then match (212) the request to one or more non-addressable asset delivery opportunities. For example, if the dissemination request specified a total audience of 400,000 females between age of 34 and 49, the system may identify one or more non-addressable asset delivery opportunities that yield an audience segment of the specified size. It will be appreciated that, because the asset delivery opportunity is non-addressable, the asset may be delivered to a much larger overall audience in order to reach the desired target audience size. In this regard, the system may preferentially seek asset delivery opportunities that index higher than average with respect to the targeted audience segment. Moreover, this analysis may take into consideration the likely opportunity cost associated with the revenues that could be obtained by selling the asset delivery opportunity to a different asset provider with a different targeted audience segment. That is, the system may identify non-addressable asset delivery opportunities for the asset provider to bid on where the asset provider has a likelihood of winning the bidding process.

Once this process has been completed, the system may output (214) data for the relevant non-addressable asset delivery opportunity options. This process may then be repeated (216) for additional asset dissemination requests. It will be appreciated that the asset provider may then enter a bid, for example, in terms of cost per thousand (CPM) impressions, and the bidding process may proceed in conventional fashion.

It should be noted, however, that the processing result is very different than conventional processes. First, the asset provider is not limited to receiving information for asset delivery opportunities for which reliable ratings information is available. Thus, the asset provider can obtain audience estimation information with regard to asset delivery opportunities having a small audience share and for targeting parameters that do not match predefined ratings categories. Moreover, the source of the audience estimation information is not limited to the audience for the programming but can specifically focus on the audience for assets having specified targeting parameters. Moreover, the sampling size and composition is not limited to ratings system participants but includes potentially all addressable audience members. As noted above, the Advatar® system of Invidi Technologies Corporation is currently delivering over 9 billion targeted impressions per month with a geographical footprint and participation rate that is rapidly expanding. Accordingly, asset providers can obtain audience estimates for asset delivery opportunities and targeted parameters for which such information is not previously been available, and can obtain potentially improved estimates due to statistical advantages.

### Use Case 2: Using Level of Interest and Conversion Data to Select ADOs

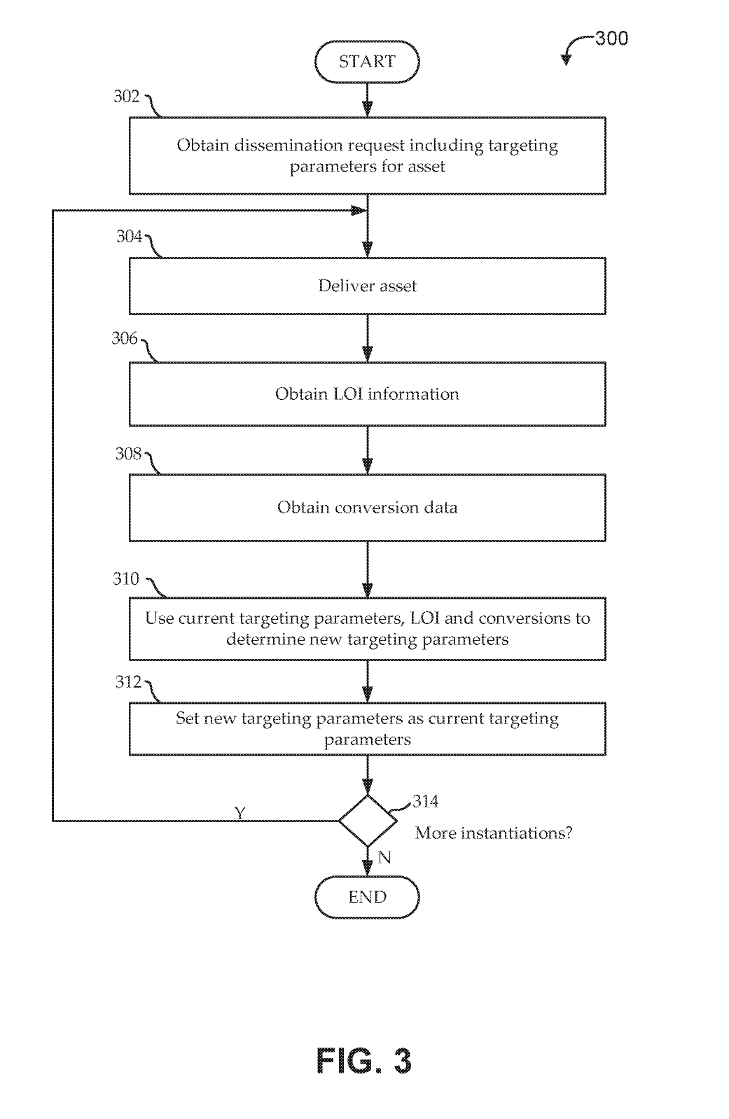

FIG. 3 illustrates a system 300 for using level of interest or conversion data to improve selection of asset delivery opportunities, i.e., addressable or non-addressable asset delivery opportunities. As discussed above, the predictive programmatic system can obtain a variety of level of interest and conversion data. It will be appreciated that this information may improve definition of targeted audiences and identification of asset delivery opportunities.

The illustrated process is initiated by obtaining (301) dissemination request information including targeting parameters an asset of interest. Again, such dissemination requests may be entered an asset provider or agent using a contracting platform. The targeting parameters may identify location, demographic, and other constraints related to the desired audience for asset at issue.

Based on the dissemination request and previously available audience information, one or more asset delivery opportunities may be identified for the asset and the asset may be delivered (304) in connection with the identified asset delivery opportunities. As noted above, the asset delivery opportunities may include addressable and non-addressable asset delivery opportunities and audiences. In either case, targeted audience members who receive the asset may be identified. In the case of addressable asset delivery opportunities, the targeted audience members may be identified by voting, reports, or the like. In the case of non-addressable asset delivery opportunities, at least some targeted audience members may be identified by polling, reports (notwithstanding that the asset delivery opportunity was not addressable) or other mechanisms.

The system may further obtain (306) level of interest information. Such information may take a variety of forms. For example, reports from audience members may indicate whether audience member received the entire asset (thereby indicating a potentially high level of interest) or tuned-away or muted the asset (thereby potentially indicating a lower level of interest). Similarly, the reports may include a goodness of fit value indicating how well the current audience matched the targeting parameters for the asset. The system may also obtain information indicating the likelihood that the targeted audience member was present and engaged. Such information may be based internal indications such as the length of time since the audience member interacted with the user equipment or external information such as sensors indicating the presence and/or identity of any current audience members.

In addition, the system may obtain (308) conversion data related to the asset. For example, the system may compile a list of audience members who received a particular asset based on report information. The system may then track information from user data systems or conversion systems to determine whether each of the users subsequently accessed a website of the asset provider, purchased a product or service of the asset provider (or a related or competing product or service) or whether the user otherwise engaged in conduct desired (or not desired) by the asset provider. The level of interest and conversion data can then be compiled for use together with other audience information.

This information has a variety of potential uses relating analyzing asset effectiveness and audience behavior. In the illustrated process 300, the system can use (310) the current targeting parameters together with the level of interest and conversion information to determine new targeting parameters or identify appropriate asset delivery opportunities. For example, a particular asset may have initial targeting parameters targeting females within a particular geographical region. Based on the level of interest and conversion data, it may be determined the asset is particularly effective in relation to females aged 35-49. This information can be used in various ways, For example, a report including such information may be provided to the asset provider or improved targeting parameters may be suggested to the asset provider in connection with a subsequent dissemination request. This process may be repeated (314) to iteratively converge on optimal targeting parameters for a particular asset or asset delivery opportunity.

This process can be used in implementing experimental campaigns for assets. For example, an asset provider may wish to test the relative effectiveness of multiple ads, to test the effectiveness of advertising in different time-slots, in different programming, at different frequencies, or the like. An experimental campaign can then be designed and implemented with due regard to utilizing randomized sampling, using a statistically significant sampling size, using appropriate control groups, running the experiment for sufficient time to measure the relevant campaign parameters, etc. An experimental campaign (where the subject assets are actually delivered to a test group) has advantages over a hypothetical investigation (where user equipment is invoked to provide audience measurement data as if the hypothetical asset view available for delivery) because level of interest and conversion data can be obtained to analyze asset effectiveness. Based on the results of the experimental campaign, an actual campaign can be optimized.

### Use Case 3: Polling and Audience Measurement

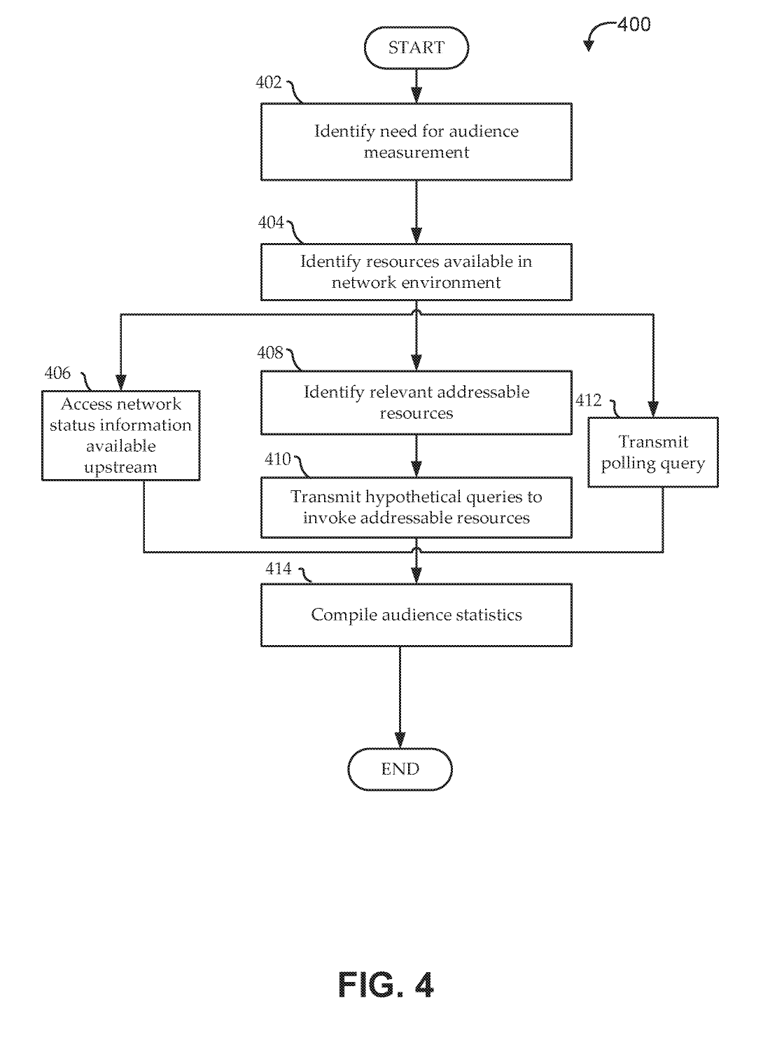

The present invention is not limited to obtaining information for use in identifying appropriate asset delivery opportunities. Rather, as noted above, the system provides a variety of information that is useful in many contexts, including measuring asset effectiveness, identifying the universe of potential consumers for a product or service, and understanding the audience for programming in which assets are delivered. FIG. 4 illustrates a process 400 for polling and audience measurement for any such purpose in connection with various network environments.

The illustrated process 400 is initiated by identifying (402) a need for audience measurement. For example, an asset provider or programming provider may contract with the operator of the predictive programmatic system to obtain analytics. Alternatively, a network provider may enlist the operator of the predictive programmatic system to conduct a survey of audience composition. As a still further example, government or other researchers may solicit information concerning how behavior is influenced by assets.

In any event, upon receiving such a request, the system operator may identify (404) resources available in one or more relevant network environments for developing the requested information. It will be appreciated that different resources may be accessed depending on the network environment. For example, in certain network environments such as unicast networks and digital switched networks, certain audience information may be available at network platforms “upstream” from the user device such as at switching node or server. In such cases, the system may access (406) network status information from such a platform. The network status information may identify whether a given user device is on, what programming or content is being consumed and other information.

In network environments where an addressable asset system is available, the system may identify (408) relevant addressable resources. For example, a large volume of audience information may be available based on voting, reporting, or other information related to addressable assets delivered in network. In addition, the system may utilized resources of the addressable asset system to transmit (410) hypothetical queries to invoke addressable resources. Thus, for example, hypothetical queries may be designed to yield audience information responsive to the audience measurement request. Such queries may be very specific, e.g., how many households are in there in a defined geographical area who have pets and an income of over 100,000. Such hypothetical queries may be transmitted to user devices as if they were targeting parameters for an actual asset though no corresponding asset is actually available for delivery. In this manner, existing voting, reporting, or other mechanisms can be invoked to yield audience information.

However, it is not necessary to submit hypothetical queries in all network environments. For example, the system may transmit (412) a polling query to some or all network users. For example, the polling query may request that user devices indicate one or more of the following: whether the user device is currently turned on, what channel or content is currently being consumed, whether it is estimated that a user is currently present and engaged, the current estimate of audience classification parameters, and any other information available to the user equipment device regarding current status. Some or all of the user equipment devices may respond with appropriate information.

In any event, the information obtained can be used to compile (414) audience statistics. For example, the audience statistics may identify information related to audience size and composition as well as interest and other information. This information may be used by the requester for any appropriate purpose.

### Use Case 4: Audience Analytics Using Conversion Data

The predictive programmatic system of the present invention can also be used to generate rich analytics using conversion data. As noted above, conversion data including subsequent data network activities and purchasing behavior is available in connection with the predictive programmatic system from a variety of sources. This information can be mined to yield a wealth of information regarding how exposure to assets influences behavior.

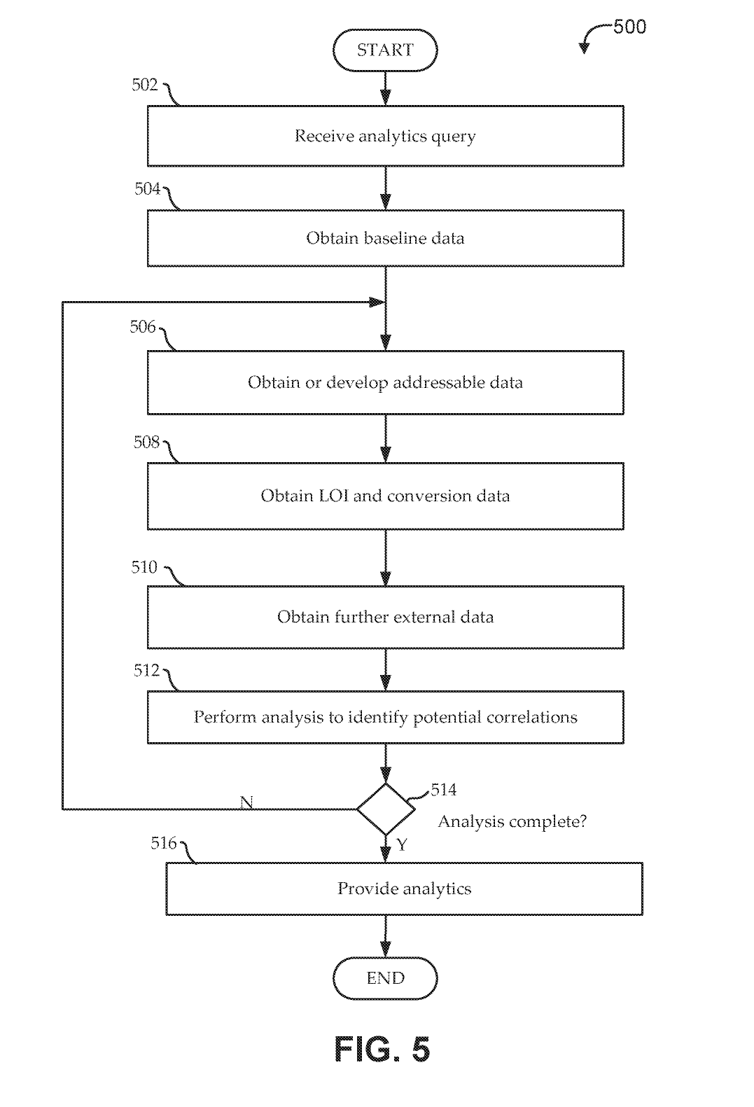

An associated process (500) is illustrated in FIG. 5. The process 500 is initiated by receiving (502) an analytics query. For example, an asset provider, researcher, or other interested party may submit a research query concerning, for example, how exposure to a particular asset affects subsequent behavior, what segments of the population react in particular ways after receiving an asset, or how the behavior of those receiving a particular asset differs from another group that did not receive the asset. For example, such an analytics query may be submitted via an interface of the predictive programmatic system. Alternatively, analytics may be developed independent any specific query.

The illustrated process 500 then proceeds by obtaining (504) baseline data. In many analyses it is important to understand baseline trends in the absence of exposure to an asset. For example, knowing that 40% of the targeted population purchased a product after receiving an asset has limited value without knowing what percentage of the relevant population purchases the product in the absence of receiving the asset. Accordingly, the system may obtain a variety of information to compile baseline data such as demographic information, purchasing behavior information, ratings information, and the like. The system can then obtain (506) or develop addressable data asset delivery system or other data for tracking users who have received a particular asset. It will be understood that, if an objective of a particular study is to determine how behavior has been influenced by receiving an asset, it is important to identify users who have received the asset. While this can be done in many ways, and the discussion above has demonstrated that such data can be obtained even with respect to non-addressable asset delivery opportunities, information and functionality of an addressable asset delivery system provides a highly effective mechanism not only for identifying who has received an asset but in identifying targeted audience members who have received an asset.

Armed with information identifying users who have received an asset, the predictive programmatic system can compile a variety of information including information concerning subsequent behavior by the users. For example, the system can obtain (508) level of interest and conversion data as described above. The conversion data may indicate subsequent websites visited by the users, purchases of relevant products and services by the user, and other activities. Additional external data may also be obtained (510) for the users. For example, an investigator may be interested in understanding various characteristics of a subset of users who purchased products of an asset provider, purchased competing products, or engaged in other activity of interest. In this regard, various public or proprietary data sources including census data, financial information, and the like may be accessed to gather information regarding the users of interest.

Once this information has been compiled, an initial analysis may be performed (512) to identify potential correlations and relationships of interest. For example, the analysis may indicate particular demographic parameters for individuals who found the asset effective or ineffective. In some cases, behaviors may be identified that were not expected or even desired. The analysis may proceed iteratively (514) to confirm correlations, seek additional correlations or relationships, or further probe initial results.

Once the analysis is complete, analytics may be provided (516) to the requesting party or stored for use in connection with subsequent processes such as asset dissemination requests.

### Use Case 5: Tracking Subsequent Network Usage

The predictive programmatic system can also be used to track subsequent network activity of users who have received an asset. For example, subsequent network usage may be tracked to identify additional opportunities to deliver assets to the targeted users. In this manner, overlooked asset delivery opportunities can be identified and revenues for asset delivery can be enhanced.

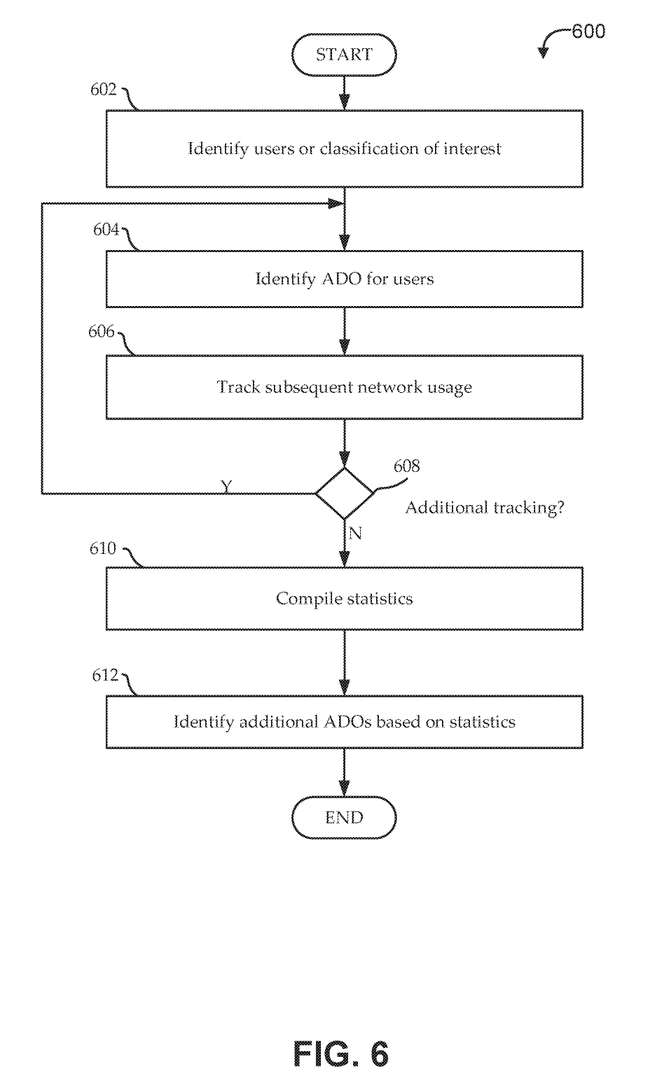

As shown in FIG. 6, an associated process 600 is initiated by identifying (602) users or classifications of interest. For example, an asset provider may provide a list of customers who have purchased a vehicle or may specify a targeted audience of, e.g., high income pet owners. In either case, the system may initially identify (604) an asset delivery opportunity for targeting the users. This may be accomplished as described above based on rating information, historical information for similar asset delivery opportunities, and the like. Based on reports or other information, the predictive programmatic system can then identify users who have received an asset under consideration.

The system can then use this information to track (606) subsequent network usage by the identified users. For example, by using a polling process, a hypothetical asset delivery request, or information associated with subsequent addressable asset delivery opportunities, the system can identify programs, networks, programming subject matter or genre, or other information characterizing network usage behavior by the users. This process can be performed iteratively (608) for the same user and for other users.

Once an adequate supply of tracking information has been collected, the system can compile (610) statistics based on the subsequent network usage. For example, it may be determined that a certain program, network, time of day, or programming subject matter index higher than average for a specified target audience. Using this information the system can identify (612) additional asset delivery opportunities. For example, potential asset delivery opportunities of interest may be suggested to asset providers using a contracting platform. The asset provider may then choose to make a spot buy or programmatic buy suggested based on the analysis.

It is anticipated that, in some cases, asset providers may view this as a benefit as such delivery opportunities may been viewed as lower value and may therefore be lower priced asset delivery opportunities. Conversely, network operators may benefit from realizing increased value of spots previously considered low value.

The foregoing description of the present invention has been presented for purposed of illustration and description. Furthermore, the description is not intended to limit the invention to the form disclosed herein. Consequently, variations and modifications commensurate with the above teachings, and skill and knowledge of the relevant art are within the scope of the present invention. The embodiments described herein above are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

1. A method for use identifying asset delivery opportunities for delivering assets to targeted audiences in a communications network, said communications network having defined asset delivery opportunities associated with network programming, said method comprising:
providing an addressable asset processing module for said communications network, said addressable asset processing module associated with an addressable asset delivery system being operative for addressing first addressable assets to audience members in connection with first addressable asset delivery opportunities of said communications network and including a communications processing module for processing communications between a platform of said addressable asset delivery system and user equipment devices of users of said communications network related to said first, addressable asset delivery opportunity; and
operating said addressable asset processing module to provide audience information, based on at least in part an said communications, concerning audience composition of second, non-addressable asset delivery opportunities.

2. A method as set for in claim 1, further comprising:
providing a non-addressable module for matching asset delivery requests to said second, non-addressable asset delivery opportunities;
first operating said non-addressable targeting module to receive at least a portion of said audience information concerning said second, non-addressable asset delivery opportunities and to receive a first asset delivery request specifying targeting parameters for a non-addressable asset for potential placement in at least a selected one of said second, non-addressable asset delivery opportunities; and
second operating said non-addressable targeting module for comparing said targeting parameters for said non-addressable asset to said portion of said audience information concerning said second, non-addressable asset delivery opportunities to select one or more of said second, non-addressable asset delivery opportunities responsive to said first asset delivery request.

3. A method as set forth in claim 1, wherein said audience information is based on communications between said platform of said addressable asset delivery system and said user devices, each said communication relating to characterizing a current audience of a given user equipment device.

4. A method as set forth in claim 3, wherein said audience information reflects one or more classification parameters of said current audience.

5. A method as set forth in claim 3, wherein said audience information identifies a bandwidth segment delivered to said current audience.

6. A method as set forth in claim 3, wherein said audience information identifies an asset delivered to said current audience.

7. A method as set forth in claim 3, wherein said audience information reflects a suitability of a potential asset for delivery to said current audience.

8. A method as set forth in claim 1, wherein said audience information includes level of interest information for audiences of said first, addressable assets.

9. A method as set forth in claim 1, wherein said audience information includes conversion information for audiences of said first, addressable assets.

10. A method as set forth in claim 1, wherein said audience information includes, for one or more targeted users of one of said first addressable assets, network usage information obtained by tracking network usage of said targeted users separate from said one or more said first addressable assets.

11. A method for use in matching assets to asset delivery opportunities in a communications network having defined asset delivery opportunities associated with network programming, comprising:
first operating a targeting module to receive asset delivery information including, for each delivered asset of multiple delivered assets: 1) audience information concerning classification parameters of an audience that received the delivered asset, and 2) audience engagement information concerning one of levels of interest and conversions for the audience that received the delivered asset;
second operating said targeting module to receive an asset delivery request for prospective delivery of a subject asset, said delivery request including one or more subject matter parameters for said subject asset; and
third operating said targeting module identifying one or more asset delivery opportunities for said subject asset based on said asset delivery information and said subject matter parameters.

12. A method as set forth in claim 11, wherein a first asset of said multiple delivered assets had first targeting parameters defining a targeted audience for delivery of said first asset, and said targeting module is operative for:
determining engagement parameters for said first asset based on said engagement information, said engagement parameters defining an engaged audience for said first asset different than said targeted audience; and
identifying said one or more asset delivery opportunities based on said engagement parameters.

13. A method as set forth in claim 11, wherein at least one of said identified asset delivery opportunities is a non-addressable asset delivery opportunity.

14. A method as set forth in claim 11, wherein said first receiving comprises obtaining information from an addressable asset delivery opportunity system.

15. A method as set forth in claim 11, wherein said first receiving comprises obtaining product purchase information for the audience that received the delivered asset.

16. A method as set forth in claim 11, wherein said subject matter parameters define a target audience for said subject asset.

17. A method as set forth in claim 11, wherein said subject matter parameters define an identity or characteristic of goods or services promoted by said subject asset.

18.-20. (canceled)

21. A system for use identifying asset delivery opportunities for delivering assets to targeted audiences in a communications network, said communications network having defined asset delivery opportunities associated with network programming, said system comprising:
an addressable asset processing module for use in said communications network, said addressable asset processing module associated with an addressable asset delivery system being operative for addressing first addressable assets to audience members in connection with first addressable asset delivery opportunities of said communications network and including a communications processing module for processing communications between a platform of said addressable asset delivery system and user equipment devices of users of said communications network related to said first, addressable asset delivery opportunity;
said addressable asset processing module being operative to provide audience information, based on at least in part an said communications, concerning audience composition of second, non-addressable asset delivery opportunities.

22. A system as set for in claim 21, further comprising:
a non-addressable module for matching asset delivery requests to said second, non-addressable asset delivery opportunities;
said non-addressable targeting module being operative for:
receiving at least a portion of said audience information concerning said second, non-addressable asset delivery opportunities and to receive a first asset delivery request specifying targeting parameters for a non-addressable asset for potential placement in at least a selected one of said second, non-addressable asset delivery opportunities; and
comparing said targeting parameters for said non-addressable asset to said portion of said audience information concerning said second, non-addressable asset delivery opportunities to select one or more of said second, non-addressable asset delivery opportunities responsive to said first asset delivery request.

23. A system as set forth in claim 21, wherein said audience information is based on communications between said platform of said addressable asset delivery system and said user devices, each said communication relating to characterizing a current audience of a given user equipment device.

24. A system as set forth in claim 23, wherein said audience information reflects one or more classification parameters of said current audience.

25. A system as set forth in claim 23, wherein said audience information identifies a bandwidth segment delivered to said current audience.

26. A system as set forth in claim 23, wherein said audience information identifies an asset delivered to said current audience.

27. A system as set forth in claim 23, wherein said audience information reflects a suitability of a potential asset for delivery to said current audience.

28. A system as set forth in claim 21, wherein said audience information includes level of interest information for audiences of said first, addressable assets.

29. A system as set forth in claim 21, wherein said audience information includes conversion information for audiences of said first, addressable assets.

30. A system as set forth in claim 21, wherein said audience information includes, for one or more targeted users of one of said first addressable assets, network usage information obtained by tracking network usage of said targeted users separate from said one or more said first addressable assets.
